(19) United States
(12) Patent Application Publication
(10) Pub. No.: US 2007/0124870 A1
(43) Pub. Date: Jun. 7, 2007

(54) Printed textile element

(75) Inventor: David Turner, Portland, OR (US)

Correspondence Address: BANNER & WITCOFF, LTD., 1100 13th STREET, N.W., SUITE 1200, WASHINGTON, DC, 20005-4051, US

(73) Assignee: NIKE, Inc., Beaverton, OR (US)

(21) Appl. No.: 11/295,144

(22) Filed: Dec. 6, 2005

(51) Int. Cl. C11D 3/00

(52) U.S. Cl. 8/115.51

(57) ABSTRACT

A printed textile element is disclosed as having a first surface and an opposite second surface. Each of the first surface and the second surface have at least a first color and a second color. The first color of the first surface is substantially aligned with and opposite the second color of the second surface, and the second color of the first surface is substantially aligned with and opposite the first color of the second surface. The textile element may be incorporated into an article of apparel, such as a shirt, or a variety of other products. A process involving the use of transfer paper for forming the textile element is also disclosed.

### BACKGROUND

Articles of apparel worn by individuals of different teams during an athletic competition assist in distinguishing the individuals of one team from the individuals of another team. Most commonly, the distinguishing factor between the articles of apparel is color. That is, the individuals of one team wear one color and the individuals of another team wear another color, with the colors being visually-distinguishable. During competition, therefore, the individuals and spectators need only scan the colors of the various individuals distributed throughout the playing area to determine the teams associated with each individual.

Many athletic teams have two sets of apparel with different colors. For example, if the colors of a particular team are blue and yellow, the team may have a first set of apparel that is primarily blue and a second set of apparel that is primarily yellow. Depending upon the apparel color worn by an opposing team, the team may select either the blue apparel or the yellow apparel to ensure that individuals from each team are visually-distinguishable. That is, by having two sets of apparel with different colors, teams may ensure that the particular sets of apparel chosen by each team are visually-distinguishable.

Although having two sets of apparel with different colors is an effective manner of ensuring that individuals from each team are visually-distinguishable, having two sets of apparel increases the costs associated with being a member of an athletic team. In addition, having two sets of apparel increases the probability that the individuals will experience confusion over the set of apparel that is chosen for a particular competition. As a means of alleviating both of these issues, some athletic teams utilize reversible articles of apparel. More particularly, the apparel may be formed to exhibit a two-layered structure wherein each layer is a different color. By turning the apparel inside-out or otherwise reversing the layer that faces outward, one of the two different colors may be located on the exterior of the apparel. Accordingly, apparel with a two-layered structure may be utilized to provide each individual with a single article of apparel that has two visually-distinct color schemes.

### SUMMARY

One aspect of the invention is a textile element that is a single layer of a textile material with a first surface and an opposite second surface. Each of the first surface and the second surface have at least a first color and a second color. The first color of the first surface is substantially aligned with and opposite the second color of the second surface, and the second color of the first surface is substantially aligned with and opposite the first color of the second surface. The textile element may be incorporated into an article of apparel, such as a shirt, or a variety of other products.

Another aspect of the invention is a method for printing. The method includes configuring a first transfer sheet and a second transfer sheet to each have at least a first color region with a first color and a second color region with a second color. The first transfer sheet and the second transfer sheet are positioned adjacent opposite surfaces of a single layer textile element such that (a) the first color region of the first transfer sheet is substantially aligned with and opposite the second color region of the second transfer sheet and (b) the second color region of the first transfer sheet is substantially aligned with and opposite the first color region of the second transfer sheet. The first color and the second color are then transferred from each of the first transfer sheet and the second transfer sheet to the opposite surfaces of the textile element.

The advantages and features of novelty characterizing various aspects of the invention are pointed out with particularity in the appended claims. To gain an improved understanding of the advantages and features of novelty, however, reference may be made to the following descriptive matter and accompanying drawings that describe and illustrate various embodiments and concepts related to the aspects of the invention.

### DESCRIPTION OF THE DRAWINGS

The foregoing Summary, as well as the following Detailed Description, will be better understood when read in conjunction with the accompanying drawings.

FIG. 1 is a first front elevational view of an article of apparel, wherein a first surface of the apparel faces outward.

FIG. 2 is a second front elevational view of the article of apparel, wherein a second surface of the apparel faces outward.

FIG. 3 is a first front elevational view of a second configuration of the article of apparel, wherein the first surface of the apparel faces outward.

FIG. 4 is a second front elevational view of the second configuration of the article of apparel, wherein the second surface of the apparel faces outward.

FIGS. 5A-5C schematically-depict a first process for printing on a textile element of the article of apparel.

FIGS. 6A-6E schematically-depict a second process for printing on a textile element of the article of apparel.

### DETAILED DESCRIPTION

The following discussion and accompanying figures disclose an article of apparel with a reversible configuration and a process for printing on a textile element of the apparel. The apparel is discussed and depicted as a short-sleeved shirt. Concepts associated with the apparel and process for printing may be applied, however, to a variety of apparel types, including headwear, long-sleeved shirts, jackets, coats, underwear, pants, shorts, and footwear, for example. In addition, the process for printing may be utilized for textile elements incorporated into a variety of other products. Accordingly, the concepts disclosed in the following material may be applied to a variety of products, in addition to apparel.

Exemplar Apparel Configuration

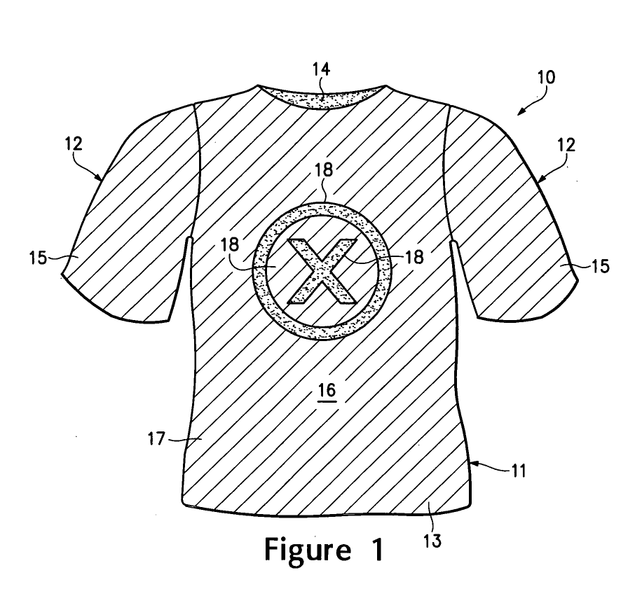

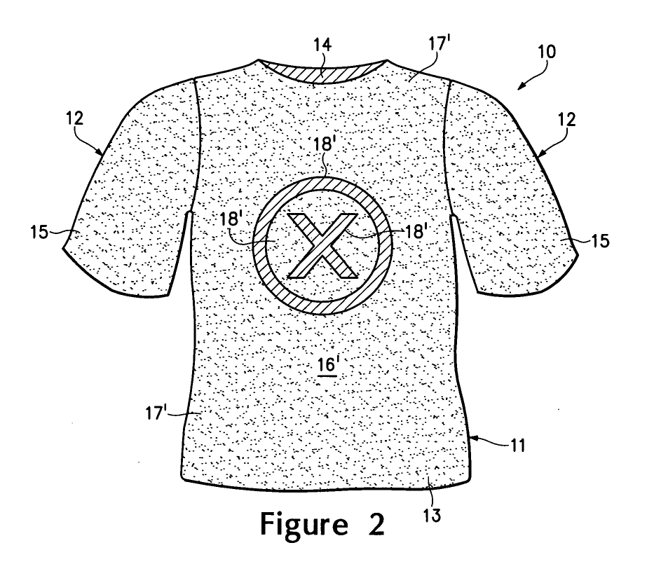

An article of apparel 10 is depicted in FIGS. 1 and 2 as having the general configuration of a short-sleeved shirt. Apparel 10 includes a torso region 11 and a pair of arm regions 12. Torso region 11 corresponds with a torso of an individual and, therefore, covers the torso when worn. Arm regions 12 correspond with arms of the individual and, therefore, cover the arms when worn. A variety of textile elements are joined in a generally conventional manner to form apparel 10. Referring to FIGS. 1 and 2, apparel 10 includes a textile element 13 that forms a front area of torso region 11. A similarly-shaped textile element 14 forms a rear area of torso region 11, and a pair of textile elements 15 form arm regions 12.

Apparel 10 has a reversible configuration. With reference to FIG. 1, apparel 10 is depicted in a configuration wherein a surface 16 of textile element 13 faces outward. With reference to FIG. 2, apparel 10 is depicted in a configuration wherein an opposite surface 16′ of textile element 13 faces outward. To convert apparel 10 between the two configurations depicted in FIGS. 1 and 2, apparel 10 may merely be turned inside-out or otherwise reversed. In order to provide an aesthetically-acceptable appearance to apparel 10, seams joining adjacent portions of textile elements 13-15 may be finished on both sides. That is, the portion of the seams that face outward when surface 16 is on an exterior of apparel 10 may be structured to exhibit a finished structure, and the portion of the seams that face outward when surface 16′ is on the exterior of apparel 10 may also be structured to exhibit a finished structure. Accordingly, apparel 10 will have a finished appearance whether surface 16 or surface 16′ is on the exterior.

Surface 16 of textile element 13 includes a background region 17 and a separate indicia region 18. Although the relative areas and positions of regions 17 and 18 may vary significantly, background region 17 is depicted as extending through a majority of the area of surface 16, and indicia region 18 is centrally located with respect to background region 17. With reference to FIG. 1, portions of surface 16 are depicted as having diagonal lines to represent a first color, and other portions of surface 16 are depicted as being stippled (i.e., dotted) to represent a second color. More particularly, background region 17 is entirely lined, whereas indicia region 18 is both lined and stippled. Accordingly, background region 17 exhibits only the first color, whereas indicia region 18 exhibits both the first color and the second color. For purposes of explanation, indicia region 18 is discussed and depicted as only including the first color and the second color, but may also include additional colors in further embodiments. The first color and the second color may be any of a variety of colors, including red, orange, yellow, green, blue, violet, white, black, grey, brown, silver, and gold, for example, or the first color and the second color may be different shades of a particular color.

Surface 16′ of textile element 13 includes a background region 17′ and a separate indicia region 18′. Utilizing the color convention discussed above for surface 16 (i.e., lined is a first color, and stippled is a second color), background region 17′ is entirely stippled, whereas indicia region 18′ is both lined and stippled. In comparison with surface 16, surface 16′ is oppositely-colored. That is, surface 16′ has the first color in locations corresponding with the second color of surface 16, and surface 16′ has the second color in locations corresponding with the first color of surface 16. Accordingly, background region 17′ exhibits the second color and indicia region 18′ exhibits both the first color and the second color, but in a color configuration that is reversed from indicia region 18. In general, therefore, the colors of surfaces 16 and 16′ are reversed.

Indicia region 18 and indicia region 18′ are substantially aligned with and opposite each other. That is, indicia region 18 is positioned to correspond in location with indicia region 18′, but is on an opposite side of textile element 13. If, for example, a pair of scissors were used to separate background region 17 from indicia region 18, then background region 17′ would also be separated from indicia region 18′ due to the substantially aligned and opposite configuration of indicia region 18 and indicia region 18′. Accordingly, positioning indicia region 18 to be substantially aligned and opposite indicia region 18′ locates indicia regions 18 and 18′ in substantially corresponding locations on the opposite sides of textile element 13.

Background regions 17 and 17′ generally provide a background against which the indicia of indicia regions 18 and 18′ is set, and regions 17, 17′, 18, and 18′ are discussed as being distinct areas. This distinction between regions 17, 17′, 18, and 18′ is intended, however, to merely provide a reference for the discussion of surfaces 16 and 16′ and also has relevance during a manufacturing process for apparel 10, as discussed in greater detail below. Accordingly, regions 17, 17′, 18, and 18′ are discussed as separate areas in order to demonstrate differences between portions of surfaces 16 and 16′.

Based upon the above discussion, textile element 13 has a configuration wherein each of surfaces 16 and 16′ are substantially identical, except for the color configuration. Textile elements 14 and 15 may have a similar configuration, wherein opposite sides are oppositely-colored. One use for apparel 10 is as apparel for an athletic team. As discussed in the Background section above, some athletic teams utilize reversible apparel that is formed to exhibit a two-layered structure wherein each layer is a different color. In contrast with these types of apparel, apparel 10 has a single layered structure wherein opposite surfaces of the single layer are differently-colored. That is, textile element 13, for example, is a single layer of a textile material and surfaces 16 and 16′ are differently-colored. By turning apparel 10 inside-out or otherwise reversing whether surface 16 or surface 16′ faces outward, one of the two different colors schemes for surfaces 16 and 16′ may be located on the exterior of apparel 10. Accordingly, apparel 10 has a single-layered structure that provides two visually-distinct color schemes.

One benefit to the single-layered structure of apparel 10 relates to potential cost savings given that apparel with a two-layered structure incorporates approximately twice as much textile material as single-layered structure. That is, the single-layered structure of apparel 10 may utilize substantially less textile material than apparel with a two-layered structure. In addition, joining textile elements of a single layered-structure (e.g., through sewing) may be less difficult due to the lesser overall number of textile elements being incorporated into the apparel. As a further matter, the single-layered structure of apparel 10 may be more air-permeable, and therefore cooler, than a two-layered article of apparel.

Indicia region 18 and indicia region 18′ are depicted for purposes of illustration as being a circle with an x-shaped symbol within the circle. A variety of other configurations for indicia regions 18 and 18′ may also be utilized. For example, indicia regions 18 and 18′ may have one or more of a name of an individual, a number associated with the individual, or a symbol associated with a team or organization that that individual is affiliated with. As noted above, one use for apparel 10 is as apparel for an athletic team. In this context, the symbol of indicia regions 18 and 18′, the first color, and the second color may be selected to correspond with symbols and colors of the athletic team. Furthermore, the name of the individual and number may correspond with the particular individual wearing apparel 10 to identify the individual during practice sessions or competitions.

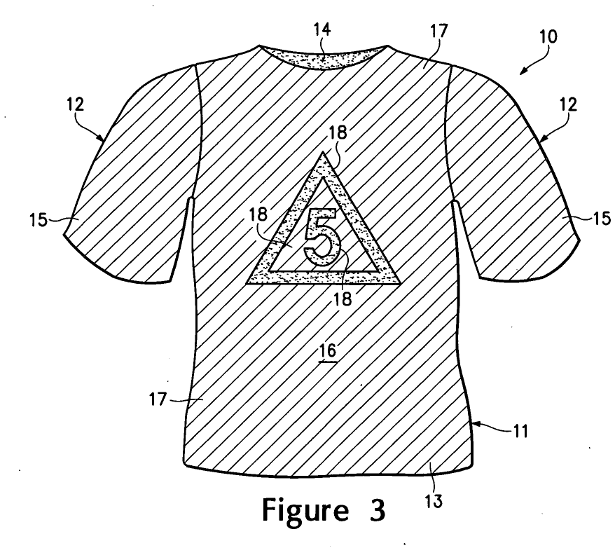

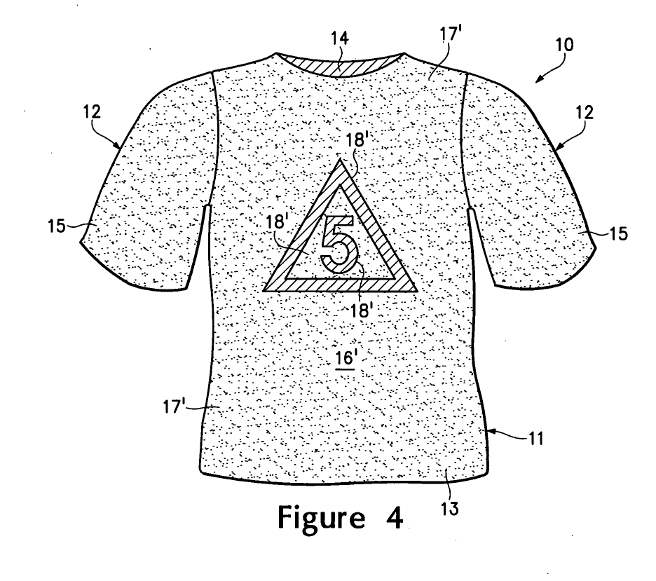

As depicted in FIGS. 1 and 2, indicia regions 18 and 18′ are symmetrical about a vertical axis. This symmetry imparts a configuration wherein each portion of indicia region 18 is substantially aligned with and opposite a corresponding portion of indicia region 18′. In some configurations of apparel 10, however, indicia regions 18 and 18′ may incorporate non-symmetrical elements. With reference to FIGS. 3 and 4, apparel 10 is depicted as having a triangular shape for each of indicia regions 18 and 18′. Within the triangular shape is the number five. The triangular shape of indicia regions 18 and 18′ are substantially aligned with and opposite each other due to the symmetry in the triangular shape. Portions of the number five, however, are not aligned with and opposite one another due to the lack of symmetry in the number five. Within the scope of the present invention, therefore, non-symmetrical elements associated with surfaces 16 and 16′ may not be substantially aligned with and opposite each other. Examples of other types of non-symmetrical elements that may be incorporated into indicia regions 18 and 18′ include other numbers, team names, symbols associated with teams, and the name of the individual, for example.

Exemplar Manufacturing Processes

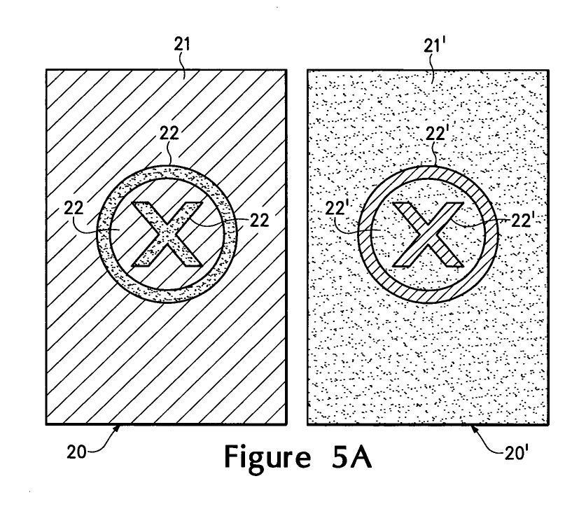

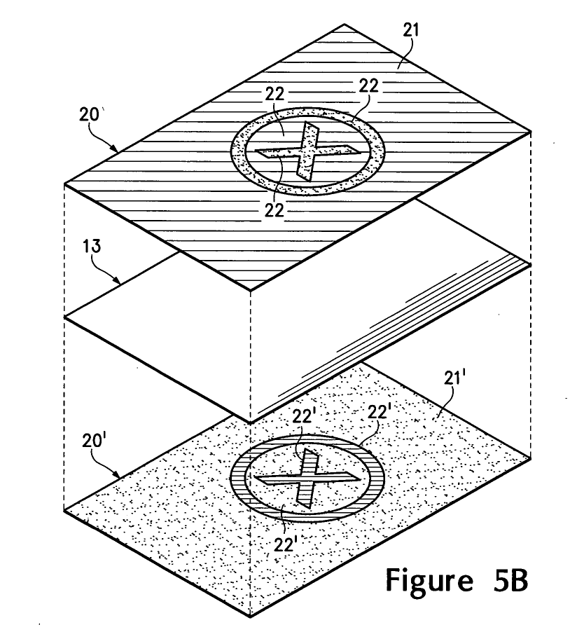

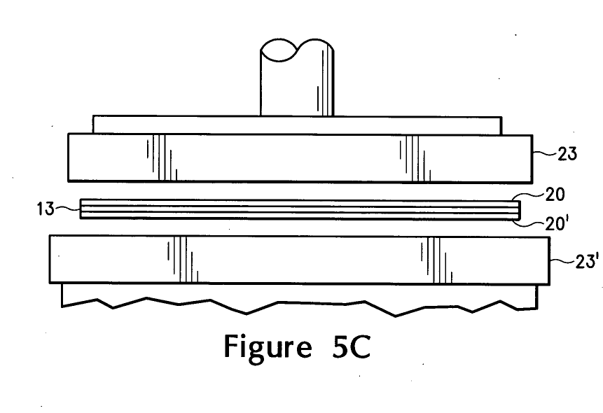

Various processes by which apparel 10 may be manufactured will now be discussed. With reference to FIG. 5A, a pair of transfer sheets 20 and 20′ are depicted. Transfer sheets 20 and 20′ have the configuration of transfer paper that is utilized to transfer color, which may be in the form of ink or dye, to a textile upon the application of one or more of heat, pressure, and an electrostatic charge. Transfer sheet 20 includes a background region 21 and an indicia region 22. Utilizing the color convention discussed above for surfaces 16 and 16′ (i.e., lined is a first color, and stippled is a second color), background region 21 is entirely stippled, whereas indicia region 22 is both lined and stippled. Similarly, transfer sheet 20′ includes a background region 21′ and an indicia region 22′, with background region 21′ being entirely lined and indicia region 22′ being both lined and stippled. In comparison with transfer sheet 20, transfer sheet 20′ is oppositely-colored. That is, transfer sheet 20′ has the first color in locations corresponding with the second color of transfer sheet 20, and transfer sheet 20′ has the second color in locations corresponding with the first color of transfer sheet 20. In general, therefore, the colors of transfer sheets 20 and 20′ are reversed. A variety of processes may be utilized to apply the first color and the second color to transfer sheets 20 and 20′, including a screen printing process and a digital printing process, for example.

Once transfer sheets 20 and 20′ are formed to have the general configuration discussed above, transfer sheets 20 and 20′ are positioned adjacent opposite surfaces of textile element 13, as depicted in FIG. 5B. In this configuration, (a) portions of transfer sheet 20 having the first color (i.e., the lined areas) are substantially aligned with and opposite portions of transfer sheet 20′ having the second color (i.e., the stippled areas) and (b) portions of transfer sheet 20 having the second color are substantially aligned with and opposite portions of transfer sheet 20′ having the first color. That is, background regions 21 and 21′ and indicia regions 22 and 22′ are substantially aligned with and opposite each other, with textile element 13 extending therebetween. Aligning corresponding portions of transfer sheets 20 and 20′ may be accomplished through the use of a registration system (e.g., registration holes in transfer sheets 20 and 20′) or any other method that provides substantial alignment between corresponding portions of transfer sheets 20 and 20′. Referring to FIG. 5B, transfer sheet 20 may appear to be facing in an upward direction (i.e., away from textile element 13), but is actually facing downward and toward textile element 13.

Following the positioning of transfer sheets 20 and 20′ on either side of textile element 13 and the alignment of corresponding portions of transfer sheets 20 and 20′, textile element 13 and transfer sheets 20 and 20′ are compressed between a pair of platens 23 and 23′ of a press, as depicted in FIG. 5C. Due to the application of one or more of heat, pressure, and an electrostatic charge from platens 23 and 23′, colors from transfer sheets 20 and 20′ (e.g., inks or dyes) migrate or are otherwise transferred to textile element 13. As noted above, the colors of transfer sheets 20 and 20′ are reversed. Accordingly, the transfer process may be controlled to ensure that colors on one side of textile element 13 do not significantly penetrate to the opposite side of textile element 13, thereby avoiding the mixing of colors on the surfaces of textile element 13. In order to control the degree to which the colors are transferred and the degree to which the colors penetrate textile element 13, the application of pressure, heat, electrostatic charge, for example, from platens 23 and 23′ may be adjusted. In addition, penetration may be controlled through the selection of inks or dyes that migrate from transfer sheets 20 and 20′ to textile element 13.

Textile element 13 is depicted as having a generally rectangular configuration. Once the colors from transfer sheets 20 and 20′ are transferred to textile element 13, a cutting process may be utilized to impart a shape to textile element 13 that is suitable for incorporating into apparel 10. That is, textile element 13 may be cut to a proper shape following the transfer of color from transfer sheets 20 and 20′ to textile element 13. The general process described above with reference to FIGS. 5A-5C may be utilized, therefore, to form textile element 13, which is subsequently incorporated into apparel 10. In some embodiments, textile element 13 may have a shape that is suitable for incorporating into apparel 10 prior to the transfer of color to alleviate the need for cutting following printing.

Although either a screen printing process or a digital printing process may be utilized to form transfer sheets 20 and 20′, neither process provides an efficient manner of forming transfer sheets having the configurations of transfer sheets 20 and 20′. More particularly, screen printing processes generally involve the formation of a separate screen for every different printing configuration. When apparel 10 is formed for a team and the various articles of apparel 10 have different numbers or different names for each individual, a separate screen would be formed for each individual. Furthermore, a digital printing process is relatively slow. Textile element 13 may have an area that exceeds six square feet for some individuals, and considerable time would be utilized to digitally print transfer sheets 20 and 20′ of this size. As discussed below, a hybrid process involving both screen printing and digital printing, for example, may be utilized to form transfer sheets utilized in printing textile element 13.

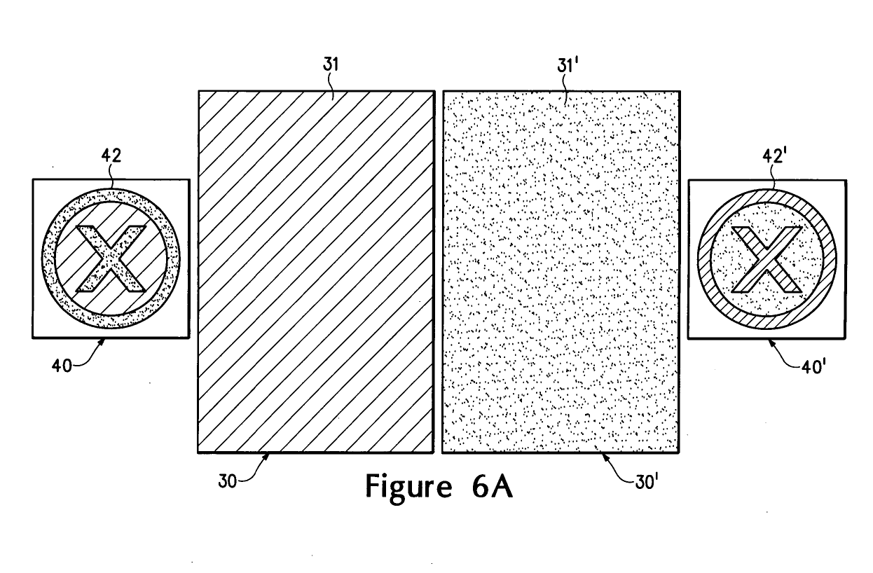

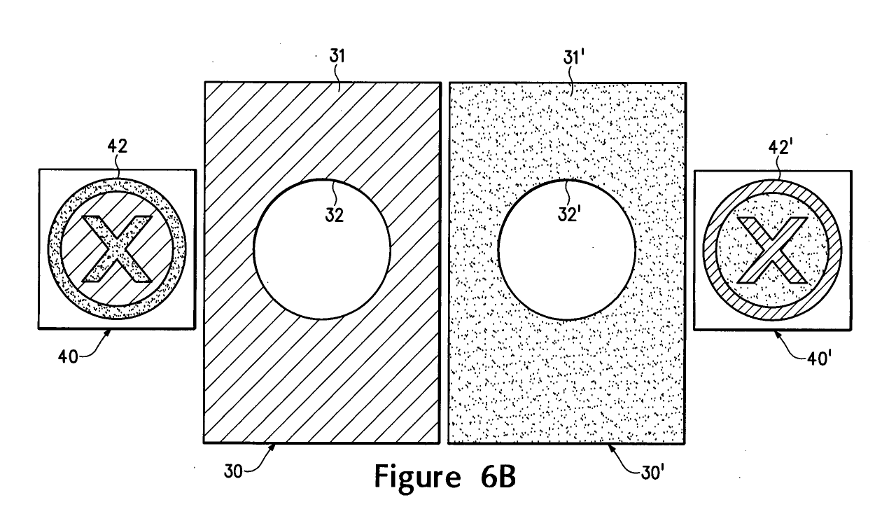

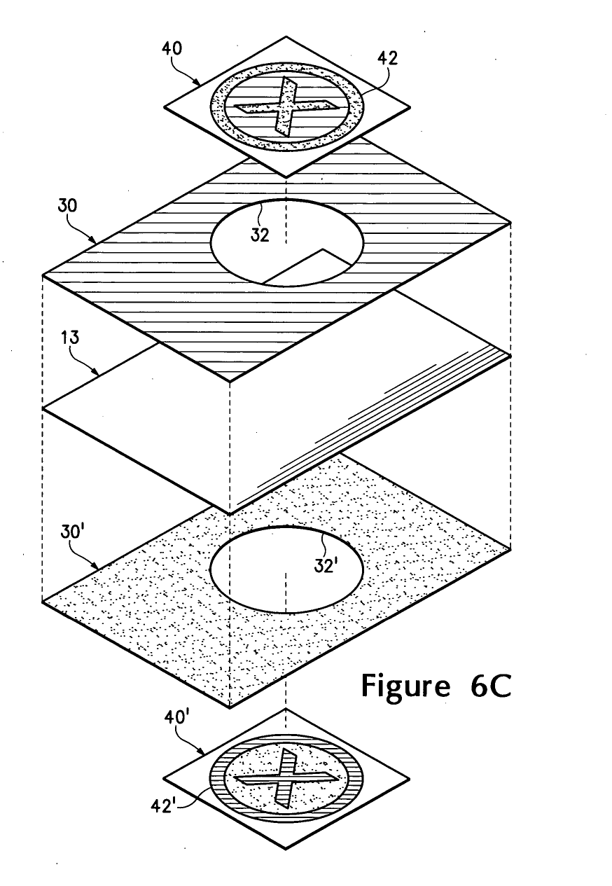

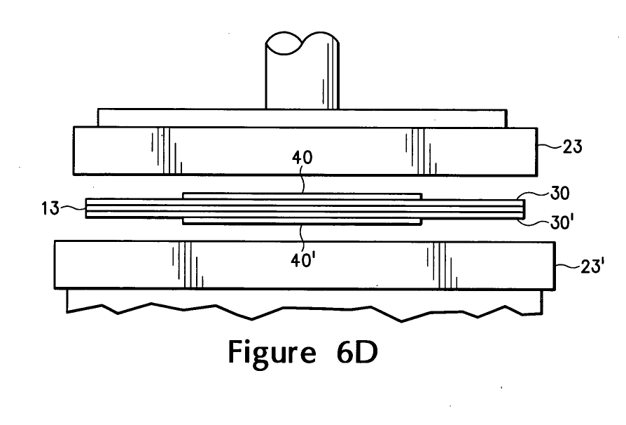

With reference to FIG. 6A, a pair of primary transfer sheets 30 and 30′ and a pair of supplemental transfer sheets 40 and 40′ are depicted. Primary transfer sheets 30 and 30′ have a substantially larger area than supplemental transfer sheets 40 and 40′. More particularly, the areas of primary transfer sheets 30 and 30′ that have color, as designated by diagonal lines and stippling, have a substantially larger area than the portions of supplemental transfer sheets 40 and 40′ with color. Given that primary transfer sheets 30 and 30′ are each formed with a single color and have a relatively large area, which respectively form background regions 31 and 31′, one suitable process for forming primary transfer sheets 30 and 30′ is screen printing. Supplemental transfer sheets 40 and 40′, which respectively include indicia regions 42 and 42′, may be formed with a digital printing process, for example, due to their smaller area and possible variation as the names or numbers of individuals are added.

Once primary transfer sheets 30 and 30′ and supplemental transfer sheets 40 and 40′ are formed to have the general configuration discussed above, an aperture 32 is formed in primary transfer sheet 30 and an aperture 32′ is formed in primary transfer sheet 30′, as depicted in FIG. 6B. The general shape of apertures 32 and 32′ correspond with the exterior bounds of indicia regions 42 and 42′. With reference to FIGS. 6A and 6B, neither of supplemental transfer sheets 40 and 40′ have color located outside of indicia regions 42 and 42′. In embodiments where apertures 32 and 32′ have greater dimensions than indicia regions 42 and 42′, supplemental transfer sheets 40 and 40′ may have color in areas beyond indicia regions 42 and 42′.

With reference to FIG. 6C, primary transfer sheets 30 and 30′ are positioned adjacent opposite surfaces of textile element 13 such that apertures 32 and 32′ are substantially aligned and on opposite sides of textile element 13. In addition, supplemental transfer sheets 40 and 40′ are positioned such that indicia regions 42 and 42′ are respectively exposed through apertures 32 and 32′. In this configuration, indicia regions 42 and 42′ are substantially aligned and on opposite sides of textile element 13. Aligning corresponding portions of transfer sheets 30, 30′, 40, and 40′ may be accomplished through the use of a registration system (e.g., registration holes) or any other method that provides substantial alignment between corresponding portions of transfer sheets 30, 30′, 40, and 40′. Referring to FIG. 6C, primary transfer sheet 30 and supplemental transfer sheet 40 may appear to be facing in an upward direction (i.e., away from textile element 13), but are actually facing downward and toward textile element 13.

The combination of primary transfer sheet 30 and supplemental transfer sheet 40, and the combination of primary transfer sheet 30′ and supplemental transfer sheet 40′, effectively form a structure that is similar to transfer sheets 20 and 20′. Accordingly, primary transfer sheet 30 and supplemental transfer sheet 40 may be considered to form a single transfer sheet suitable for printing surface 16 of textile element 13, and primary transfer sheet 30′ and supplemental transfer sheet 40′ may be considered to form a single transfer sheet suitable for printing surface 16′ of textile element 13, as discussed in greater detail below.

Following the positioning of transfer sheets 30, 30′, 40, and 40′ on either side of textile element 13 and the alignment of corresponding portions of transfer sheets 30, 30′, 40, and 40′, textile element 13 and transfer sheets 30, 30′, 40, and 40′ are compressed between platens 23 and 23′ of the press, as depicted in FIG. 6D. Due to the application of one or more of heat, pressure, and an electrostatic charge from platens 23 and 23′, colors from transfer sheets 30, 30′, 40, and 40′ (e.g., inks or dyes) migrate or are otherwise transferred to textile element 13. As is apparent from FIGS. 6A and 6B, for example, the colors of transfer sheets 30, 30′, 40, and 40′ are reversed. Accordingly, the transfer process may be controlled to ensure that colors on one side of textile element 13 do not significantly penetrate to the opposite side of textile element 13, thereby avoiding the mixing of colors on the surfaces of textile element 13. In order to control the degree to which the colors are transferred and the degree to which the colors penetrate textile element 13, the application of pressure, heat, electrostatic charge, for example, from platens 23 and 23′ may be adjusted. In addition, penetration may be controlled through the selection of inks or dyes that migrate from transfer sheets 30, 30′, 40, and 40′ to textile element 13.

Once the colors from transfer sheets 30, 30′, 40, and 40′ are transferred to textile element 13, a cutting process may be utilized to impart a shape to textile element 13 that is suitable for incorporating into apparel 10. That is, textile element 13 may be cut to a proper shape following the transfer of color from transfer sheets 30, 30′, 40, and 40′ to textile element 13. The general process described above with reference to FIGS. 6A-6D may be utilized, therefore, to form textile element 13, which is subsequently incorporated into apparel 10. In some embodiments, textile element 13 may have a shape that is suitable for incorporating into apparel 10 prior to the transfer of color to alleviate the need for cutting following printing.

Background regions 17 and 17′ and indicia regions 18 and 18′ are discussed above as being distinct areas. This distinction between regions 17, 17′, 18, and 18′ is intended, however, to merely provide a reference for the discussion of surfaces 16 and 16′ and to represent areas that are separated in the process of FIGS. 6A-6D in order to define the relative areas of transfer sheets 30, 30′, 40, and 40′. In some embodiments, primary transfer sheets 30 and 30′ may incorporate portions of the indicia associated with surfaces 16 and 16′. For example, portions of the indicia that do not change from one article of apparel 10 to another article of apparel 10 (e.g., team name and symbol) may be incorporated into primary transfer sheets 30 and 30′ to form background regions 17 and 17′, whereas portions that change with every article of apparel 10 (e.g., the name and number of a particular individual) may be incorporated into secondary transfer sheets 40 and 40′ to form indicia regions 18 and 18′. Accordingly, the distinction between regions 17, 17′, 18, and 18′ is intended to provide a reference for the above discussion.

Further Considerations

A variety of colors are suitable for apparel 10, including red, orange, yellow, green, blue, violet, white, black, grey, brown, silver, and gold, for example, or the colors may be different shades of a particular color. Although white is a suitable color, other colors located on an opposite surface of textile element 13 may be visible through the white color. That is, some inks and dyes having a white color may permit colors from an opposite surface to be visible. Accordingly, non-white colors may be utilized in some embodiments of apparel 10. Textile element 13 may also have a white color prior to printing. If white is utilized for one of the colors, then white may be imparted to apparel 10 through an absence of inks or dyes in a particular area.

FIGS. 1-4 depict apparel 10 as having colors that are substantially reversed on surfaces 16 and 16′. In some embodiments of apparel 10, various areas may include colors that are not reversed. More particularly, a third color may be introduced into indicia regions 18 and 18′, and the third color may be located on both of surfaces 16 and 16′ and in locations that are substantially aligned with and opposite each other. As an example, the x-shaped portion of indicia regions 18 and 18′ may be substantially formed from the second color on surface 16 and the first color on surface 16′. A center of the x-shaped portion, however, may be a third color on both of surfaces 16 and 16′. Accordingly, the center of the x-shaped portion may have the same color on both surfaces 16 and 16′. As another example, corresponding portions of the x-shaped portion associated with indicia regions 18 and 18′ may be white or may not include an ink or dye on each of surfaces 16 and 16′.

Textile element 13 is discussed above as having reversed colors on opposite surfaces 16 and 16′. Some or all of textile elements 14 and 15 may also have reversed colors to impart the general color scheme of textile element 13 to a remainder of apparel 10. Although textile elements 14 and 15 may only have the first color on one surface and the second color on an opposite surface, any or all of textile elements 14 and 15 may also incorporate indicia (e.g., symbols, team names, individual names, or numbers). Accordingly, processes similar to the printing processes discussed relative to FIGS. 5A-5C and 6A-6D may be utilized for textile elements 14 and 15.

Apparel 10, and particularly textile element 13, is discussed above and depicted in the figures as having a reversed color scheme. That is, the colors associated with indicia regions 18 and 18′ are reversed on surfaces 16 and 16′. In some embodiments, indicia regions 18 and 18′, for example, may have different colors. That is, indicia region 18 may have the first color and the second color, and indicia region 18′ may have a third color and a fourth color that is substantially aligned with and opposite the first color and the second color.

In joining textile elements 13-15, a conventional sewing process may be utilized, but adhesives, such as thermoplastic polymer adhesives, or other joining techniques may also be utilized. A variety of textile types may be utilized for textile elements 13-15, including non-woven materials and textiles formed by mechanically-manipulating yarns (i.e., knitting and weaving), whether formed from natural fibers (e.g., cotton, silk, wool), synthetic fibers (e.g., polyester, nylon, estane), or combinations of natural and synthetic fibers. Mesh textiles may also be utilized to enhance the air-permeability of apparel 10. In general, the textiles that area selected for apparel 10 will have properties that absorb, bond with, or otherwise join with the ink or dye in order to permanently join the ink or dye to apparel 10. Suitable inks or dyes include any of the conventional inks and dyes utilized for apparel applications.

Based upon the above discussion, apparel 10 has a reversible configuration wherein opposite surfaces display different colors. By reversing the surface that faces outward from apparel 10, the color displayed by apparel 10 is changed. As discussed in the Background section above, some athletic teams utilize reversible apparel that is formed to exhibit a two-layered structure wherein each layer is a different color. In contrast with these types of apparel, apparel 10 has a single layered structure wherein opposite surfaces of the single layer are differently-colored. That is, textile element 13, for example, is a single layer of a textile material and surfaces 16 and 16′ are differently-colored. By turning apparel 10 inside-out or otherwise reversing whether surface 16 or surface 16′ faces outward, one of the two different colors schemes for surfaces 16 and 16′ may be located on the exterior of apparel 10. Accordingly, apparel 10 has a single-layered structure that provides two visually-distinct color schemes.

Concepts associated apparel 10 and the processes for printing may be applied to a variety of apparel types and various other products. Although the apparel and products may be reversible such that the individual may select which of two opposite surfaces face outward, textile elements having reversed color schemes may also be utilized in non-reversible apparel and products. For example, the aesthetic appeal of a particular garment may be enhanced if the exterior surface is oppositely-colored in comparison with an interior surface, even if the garment is not reversible.

The invention is disclosed above and in the accompanying drawings with reference to a variety of embodiments. The purpose served by the disclosure, however, is to provide an example of the various features and concepts related to aspects of the invention, not to limit the scope of aspects of the invention. One skilled in the relevant art will recognize that numerous variations and modifications may be made to the embodiments described above without departing from the scope of the invention, as defined by the appended claims.

That which is claimed is:

1. A textile element comprising a single layer of a textile material with a first surface and an opposite second surface, each of the first surface and the second surface having at least a first color and a second color, the first color of the first surface being substantially aligned with and opposite the second color of the second surface, and the second color of the first surface being substantially aligned with and opposite the first color of the second surface.

2. The textile element recited in claim 1, wherein the textile element is incorporated into an article of apparel.

3. The textile element recited in claim 2, wherein the article of apparel is a shirt.

4. The textile element recited in claim 1, wherein neither the first color nor the second color are white.

5. An article of apparel comprising a textile element formed as a single layer of a textile material, the textile element having:
a first surface with a first background region and a first indicia region, the first background region being a first color, and at least a portion of the first indicia region being a second color; and
a second surface with a second background region and a second indicia region, the second background region being the second color, and at least a portion of the second indicia region being the first color,
wherein the first surface and the second surface are opposite sides of the textile element, the first background region and the second background region being substantially aligned with and opposite each other, and the first indicia region and the second indicia region being substantially aligned with and opposite each other.

6. The article of apparel recited in claim 5, wherein the article of apparel is a shirt.

7. The article of apparel recited in claim 5, wherein neither the first color nor the second color are white.

8. The article of apparel recited in claim 5, wherein a finished seam joins the textile element with another textile element.

9. The article of apparel recited in claim 5, wherein the first indicia region is symmetrical about at least one axis.

10. A method for printing, the method comprising steps of:
configuring a first transfer sheet and a second transfer sheet to each have at least a first color region with a first color and a second color region with a second color;
positioning the first transfer sheet and the second transfer sheet adjacent opposite surfaces of a single layer textile element such that:
(a) the first color region of the first transfer sheet is substantially aligned with and opposite the second color region of the second transfer sheet, and
(b) the second color region of the first transfer sheet is substantially aligned with and opposite the first color region of the second transfer sheet; and
transferring the first color and the second color from each of the first transfer sheet and the second transfer sheet to the opposite surfaces of the textile element.

11. The method recited in claim 10, wherein the step of configuring includes forming the first transfer sheet to be a single sheet of transfer material.

12. The method recited in claim 10, wherein the step of configuring includes forming the first transfer sheet to be (a) a first primary transfer sheet that defines an aperture with a shape of the second color region and (b) a first supplemental transfer sheet positioned adjacent the aperture.

13. The method recited in claim 12, wherein the step of configuring further includes forming the first primary transfer sheet to have only the first color and also forming the first supplemental transfer sheet to have at least the second color.

14. The method recited in claim 12, wherein the step of configuring further includes forming the first primary transfer sheet through one printing process and forming the first supplemental transfer sheet through a different printing process.

15. The method recited in claim 12, wherein the step of configuring further includes forming the first supplemental transfer sheet through a digital printing process and forming the first primary transfer sheet through a different printing process.

16. The method recited in claim 10, further including a step of incorporating the textile element into an article of apparel.

17. A method for printing, the method comprising steps of:
positioning a first transfer sheet adjacent a first surface of a single layer textile element, the first transfer sheet having a first background region and a first indicia region, the first background region being a first color, and at least a portion of the first indicia region being a second color;
positioning a second transfer sheet adjacent a second surface of the textile element, the second transfer sheet having a second background region and a second indicia region, the second background region being the second color, and at least a portion of the second indicia region being the first color;
substantially aligning the first indicia region with the second indicia region;
transferring the first color and the second color from (a) the first transfer sheet to the first surface of the textile element and (b) the second transfer sheet to the second surface of the textile element.

18. The method recited in claim 17, wherein the step of positioning the first transfer sheet includes forming the first transfer sheet to be a single sheet of transfer material.

19. The method recited in claim 17, wherein the step of positioning the first transfer sheet includes forming the first transfer sheet to be (a) a first primary transfer sheet that defines an aperture with a shape of the first indicia region and (b) a first supplemental transfer sheet positioned adjacent the aperture.

20. The method recited in claim 19, wherein the step of configuring further includes forming the first primary transfer sheet through one printing process and forming the first supplemental transfer sheet through a different printing process.

21. The method recited in claim 19, wherein the step of configuring further includes forming the first supplemental transfer sheet through a digital printing process and forming the first primary transfer sheet through a different printing process.

22. The method recited in claim 19, wherein the step of positioning the first transfer sheet further includes forming the first primary transfer sheet to have only the first color and also forming the first supplemental transfer sheet to have at least the second color.

23. The method recited in claim 17, further including a step of incorporating the textile element into an article of apparel.

24. A method for manufacturing an article of apparel, the method comprising steps of:
defining apertures in each of a first primary transfer sheet and a second primary transfer sheet, the first primary transfer sheet having a first color and the second primary transfer sheet having a second color;
positioning a first supplemental transfer sheet adjacent the aperture of the first primary transfer sheet, at least a portion of the first supplemental transfer sheet having the second color;
positioning a second supplemental transfer sheet adjacent the aperture of the second primary transfer sheet, at least a portion of the second supplemental transfer sheet having the first color;
substantially aligning the apertures on opposite sides of a single layer textile element;
transferring the first color from the first primary transfer sheet and the second color from the first supplemental transfer sheet to a surface of the textile element;
transferring the second color from the second primary transfer sheet and the first color from the second supplemental transfer sheet to an opposite surface of the textile element; and
joining the textile element to another textile element to incorporate the textile element into an article of apparel.

25. The method recited in claim 24, further including a step of forming the first primary transfer sheet through one printing process and forming the first supplemental transfer sheet through a different printing process.

26. The method recited in claim 24, further including a step of forming the first supplemental transfer sheet through a digital printing process and forming the first primary transfer sheet through a different printing process.
